(19) United States
(12) Patent Application Publication
(10) Pub. No.: US 2014/0258137 A1
(43) Pub. Date: Sep. 11, 2014

(54) Collaborative Product Development System

(71) Applicant: SKIYAKI Inc., Tokyo (JP)

(72) Inventor: Takuya Miyase, Tokyo (JP)

(73) Assignee: SKIYAKI Inc., Tokyo (JP)

(21) Appl. No.: 14/170,640

(22) Filed: Feb. 2, 2014

(30) Foreign Application Priority Data
Mar. 6, 2013 (JP) 2013-062882

(51) Int. Cl. G06Q 10/10

(52) U.S. Cl. CPC G06Q 10/101
USPC 705/300

(57) ABSTRACT

A web-based collaborative product development system for facilitating collaborative development of a product by multiple user entities. The collaborative product development system includes a collaborative product development site and user entity terminals. The collaborative product development site includes an invitation component that allows an originating user entity or entities to invite other user entities to create a product based on consumer preferences, a reception/verification component that enables the originating user entity or entities to accept bids from other user entities in response to the invitation and select a winner or winners as collaborators, and a collaboration component employed by the user entities to jointly develop the product. The user entity terminals provide access to the collaborative product development system via an internet or intranet connection.

### CROSS-REFERENCE TO RELATED APPLICATION

This patent application is based on and claims priority pursuant to 35 U.S.C. §119(a) to Japanese Patent Application No. 2013-062882, filed on Mar. 6, 2013, the entire disclosure of which is hereby incorporated by reference herein.

### BACKGROUND

1. Technical Field

The present invention relates to a collaborative product development system for use by multiple creative entities to effectively utilize their individual areas of expertise and collaborate in the joint development and commercialization of revolutionary new products (including a variety of products, goods, and merchandise).

2. Background Art

In product development, understanding the wants and needs of the ordinary consumers who are the users of the product and engaging in the necessary manufacture and marketing are carried out as a matter of course.

More recently, with the spread of computers, the internet, and on-line shopping, systems have been proposed that collate data on on-line consumers and their preferences and which use that information to develop products and solicit bids from enterprises to manufacture and then market those products. Once a successful bidder is identified, the system places an order to manufacture and market the product with the winning entity.

Although such systems are indeed capable of effectively managing the development of products in response to the needs of consumers, and to some extent of manufacturing and marketing such products, there are limits to what these systems can achieve in the way of innovation.

In particular, enterprises in very different fields are now starting to join together to pool their expertise in different fields and jointly research and develop innovative new products. Creative people from different backgrounds, having different fields of expertise and different values, share ideas and collaborate to provide exciting new products that have never been seen before.

The problem lies in providing a platform that allows user entities to share ideas across different physical and virtual boundaries, at different levels, and at different stages of the product life cycle.

### SUMMARY

The present invention provides a novel collaborative product development system for facilitating collaborative development of a product by multiple user entities. The collaborative product development system includes a collaborative product development site and user entity terminals. The collaborative product development site includes an invitation component that allows an originating user entity or entities to invite other user entities to create a product based on consumer preferences; a reception/verification component that enables the originating user entity or entities to accept bids from other user entities in response to the invitation and select a winner or winners as collaborators; and a collaboration component employed by the user entities to jointly develop the product. The user entity terminals provide access to the collaborative product development system via an internet or intranet connection.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is an overall schematic view of the architecture of a collaborative product development system according to one embodiment of the present disclosure;

FIG. 2 is a functional block diagram of the collaborative product development site shown in FIG. 1; and

FIG. 3 is a flowchart showing steps in a process of developing a collaborative product with the collaborative product development system of the present disclosure.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In developing a collaborative product, a user entity invites other user entities to join in the development effort via a collaborative product development site. That user entity then chooses collaborative partners from among those responding to the invitation. These user entities then collaborate to jointly develop a product that is innovative and new. The thus-configured collaborative product development system enables multiple user entities to interact with each other at different stages in the product life cycle using different degrees or levels of collaboration.

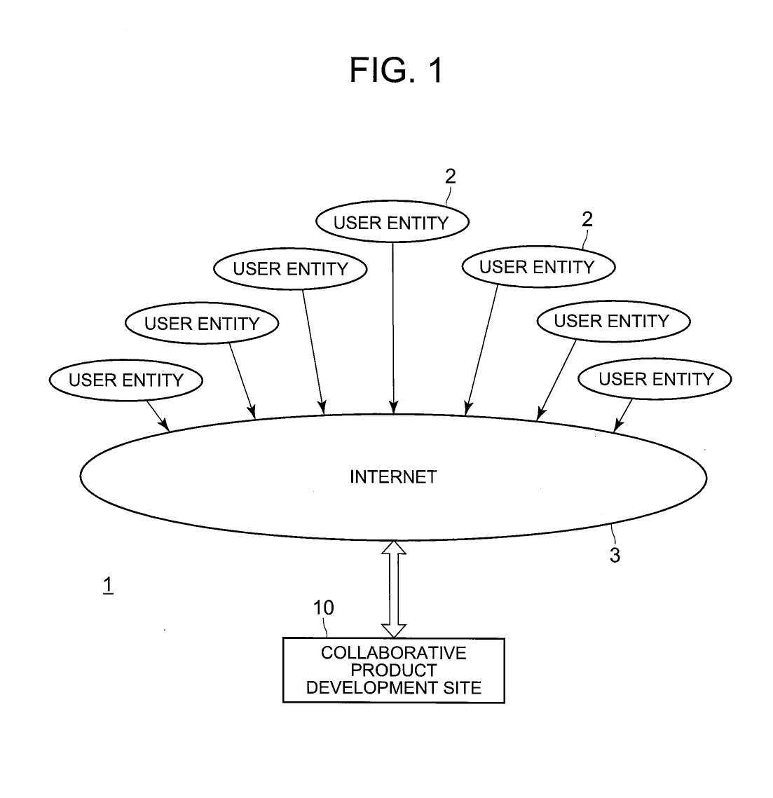

FIG. 1 is an overall schematic view of the architecture of a collaborative product development system 1 according to one embodiment of the present disclosure. User entities 2 who carry out collaborative product development prepare a collaborative product development site 10 accessed through the internet 3.

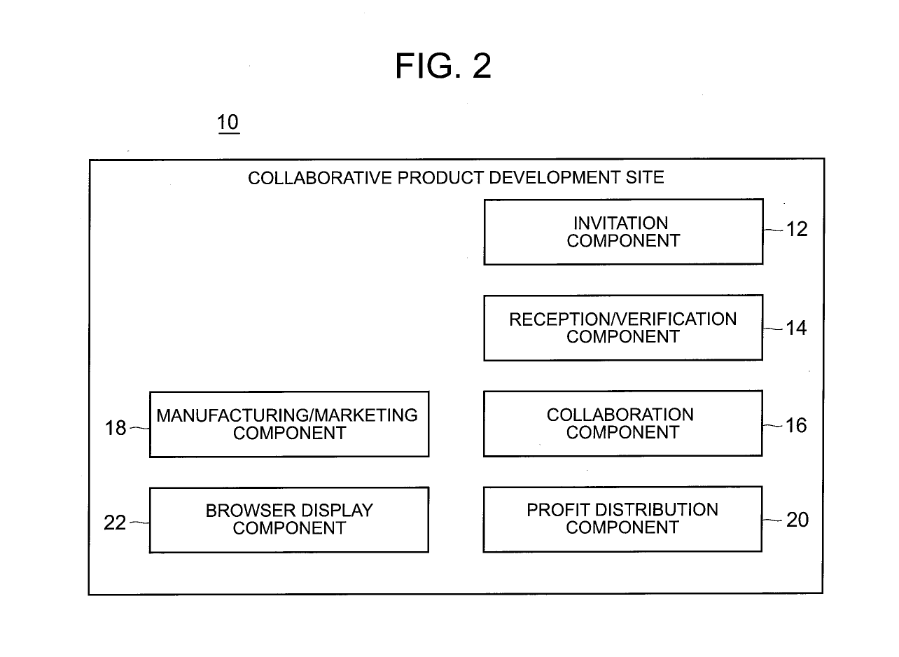

FIG. 2 is a functional block diagram of the collaborative product development site 10 shown in FIG. 1. The collaborative product development site 10 is implemented as a combination of hardware and software, in particular a server or a group of servers as well as operating systems and software applications capable of supporting different formats and programs. Preferably, the collaborative product development site 10 is a community site that can be accessed by user entities who register with the site, using whatever procedure at hand. The collaborative product development site 10 is comprised of an invitation component 12 that allows one user entity to solicit other user entities to create a new product based on consumer preferences, a reception/verification component 14 that accepts bids from other user entities in response to the invitation and selects a winner or winners, and a collaboration component 16 engaged by the user entities to jointly develop a desired product.

The range of collaborative products that can be developed through collaboration on the above-described collaborative product development site 10 is large, and includes, but is not limited to: designs; art; musical notes; electronic instruments; terminals; and so forth. The product could, for example, be as simple as a combination of lyrics and song. The product could also be a combination of a finished product with an addition, such as the addition of designs to T-shirts, smartphones, photo books, figures or figurines, etc. In short, anything that can be created collaboratively can be a collaborative product.

The present disclosure further contemplates collaboration that extends beyond the manufacture by one user entity of a product possessed by another user entity as described above. For example, one or several user entities may use the collaborative product development site 10 to gather data on consumer preferences and solicit bids to jointly develop a product that meet those needs essentially from scratch. Alternatively, one user entity may exhibit a prototype or model to be used to create follow-on new products, so-called secondary creation.

Moreover, it is contemplated that the collaborative product development site 10 is configured so as to support a creative community that is both large and diverse, enabling both enterprises and individual users from many different fields of expertise to work together through the collaborative product development site 10. Toward that end, the collaborative product development site 10 of the present disclosure is further comprised of a manufacturing/marketing component 18 that facilitates the manufacture and marketing of the collaborative product and a profit distribution component 20 that shares the profits from the sales of the product.

It is to be noted that the manufacturing facilitated by the manufacturing/marketing component 18 may be carried out either prior to marketing, thereby marketing a prepared product, or subsequent to marketing, thereby manufacturing a product in response to orders generated by marketing. In addition, there are no particular limitations on the way the profits from the sale of the product are shared. Accordingly, profit sharing may be governed by agreement or contract, by degree of contribution to product design and development, or by some other arrangement as the parties deem fit.

The collaborative product development site 10 is further comprised of a browser display component 22 that supports browsing and on-line sales of the collaborative product. Additionally, the browser display component 22 may also be used to provide publicity for the collaborative development of a product on the collaborative product development site 10. Links may be provided to various support services including legal and intellectual property resources, to exploit the product to the fullest.

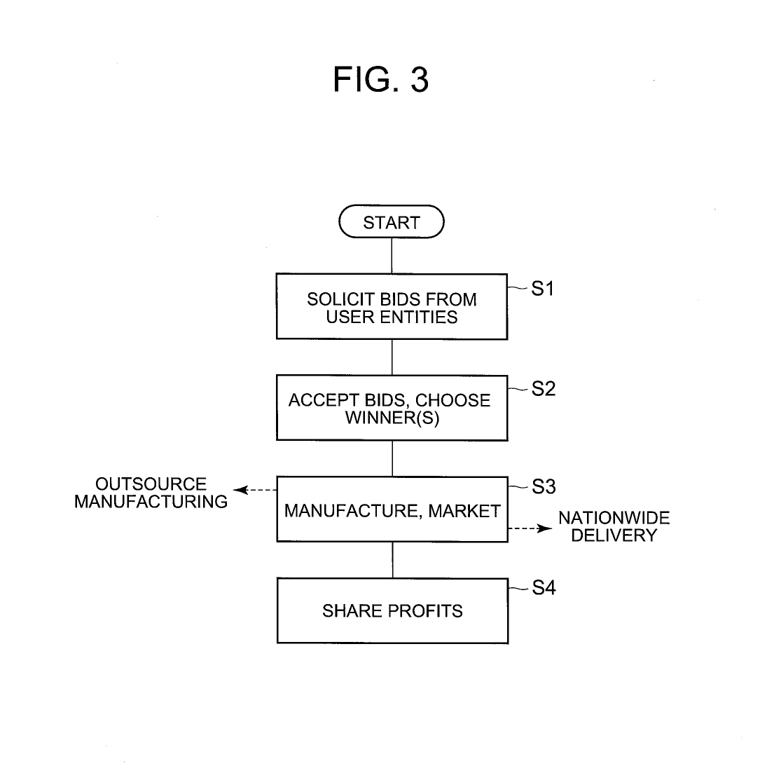

FIG. 3 is a flowchart showing steps in a process of developing a collaborative product with the collaborative product development system of the present disclosure.

In step S1, one user entity invites other user entities to collaborate in the development of a product. In step S2, the originating user accepts bids from other user entities in the creative community and, using propriety or other criteria including logarithms, the originating entity selects one or more collaborative partners from among the user entities submitting bids. In step S3, the collaborative product obtained as a result of the collaboration is manufactured. This manufacture may be done directly by one of the collaborators or it may be sub-contracted to a third party as convenient. Once manufactured, the collaborative product is then marketed. In this case, marketing is nationwide. Finally, in step S4, the profits from the sale of the collaborative product are shared.

Additional modifications and variations of the present invention are possible in light of the above teachings. It is therefore to be understood that, within the scope of the appended claims, the invention may be practiced other than as specifically described herein.

What is claimed is:

1. A web-based collaborative product development system for facilitating collaborative development of a product by multiple user entities, comprising:
a collaborative product development site comprising:
an invitation component that allows an originating user entity or entities to invite other user entities to create a product based on consumer preferences;
a reception/verification component that enables the originating user entity or entities to accept bids from other user entities in response to the invitation and select a winner or winners as collaborators; and
a collaboration component employed by the user entities to jointly develop the product; and
user entity terminals that provide access to the collaborative product development system via an internet or intranet connection.

2. The collaborative product development system according to claim 1, wherein the collaborative product development site further comprises:
a manufacturing/marketing component that facilitates manufacture and marketing of the collaborative product; and
a profit distribution component that supports division of profits from sales of the collaborative product among collaborating user entities.

3. The collaborative product development system according to claim 2, wherein the collaborative product development site further comprises a browser display component that supports browsing and on-line sales of the collaborative product.

4. A collaborative product development method of developing a product collaboratively by multiple user entities, comprising:
an originating user entity or entities inviting other user entities to collaborate in development of a product;
the originating user entity or entities accepting bids from the other user entities and selecting one or more collaborative partners from among the user entities submitting bids;
manufacturing and marketing collaborative product; and
dividing profits from sale of the collaborative product among the user entities.

5. A processor-readable non-volatile storage medium storing program code that, when executed by a computer, causes the processor to execute a collaborative product development method of developing a product collaboratively by multiple user entities,
the collaborative product development method comprising:
an originating user entity or entities inviting user entities to collaborate in development of a product;
the originating user entity or entities accepting bids from other user entities and selecting one or more collaborative partners from among the user entities submitting bids;
manufacturing and marketing collaborative product; and
dividing profits from sale of the collaborative product among the user entities.
